(19) United States
(12) Patent Application Publication
(10) Pub. No.: US 2006/0001317 A1
(43) Pub. Date: Jan. 5, 2006

(54) Vehicle anti-thief system

(75) Inventors: Kuo-Rong Chen, Banciao City (TW); Chun-Chung Lee, Taipei City (TW); Cheng-Hung Huang, Gongguan Township (TW)

Correspondence Address: BACON & THOMAS, PLLC, 625 SLATERS LANE, FOURTH FLOOR, ALEXANDRIA, VA, 22314, US

(73) Assignee: Sin Etke Technology Co., Ltd., Taipei City (TW)

(21) Appl. No.: 10/950,393

(22) Filed: Sep. 28, 2004

(30) Foreign Application Priority Data
Jun. 30, 2004 (TW) 093119659

(51) Int. Cl. B60L 1/00

(52) U.S. Cl. 307/10.1

(57) ABSTRACT

A vehicle anti-thief system is disclosed to include an anti-thief controller that controls on-vehicle electronic components of the vehicle to execute a corresponding abnormal operation, for example, repeatedly locking and unlocking the central lock, repeatedly moving the electric power seat forwards and backwards, driving the fuel pump to pump fuel to the engine intermittently, or driving the shift position sensor to output a same shift position signal, thereby obstructing and hindering from driving the vehicle and causing the thief to suffer from nerves and to give up stealing the vehicle.

### BACKGROUND OF THE INVENTION

1. Field of the Invention

The present invention relates to an anti-thief system and more particularly, to a vehicle anti-thief system that obstructs and hinders normal driving of the vehicle upon intrusion of a thief.

2. Description of Related Art

When stealing a car, the thief will, at the first stage, search the object car and walk slowly around the object car and see the surroundings and then open the door of the object car with a tool when no body around, secondarily, the thief will start the engine and drive the object car away.

A conventional motor vehicle alarm system can only produce an alarm signal to threaten the thief during the aforesaid first stage. Once the thief has entered the car, the motor vehicle alarm system provides no further measures to obstruct the thief from stealing the car.

### SUMMARY OF THE INVENTION

The present invention has been accomplished under the circumstances in view. It is therefore the main object of the present invention to provide a vehicle anti-thief system that obstructs and hinders normal functioning of the car upon intrusion of a thief, causing the thief to give up stealing the car.

To achieve this and other objects of the present invention, the vehicle anti-thief system comprises an anti-thief controller, a global positioning device, a wireless communication device, and at least one on-vehicle electronic component. The anti-thief controller has connected thereto a plurality of vehicle abnormality detection sensors. The anti-thief controller starts the global positioning device and the wireless communication device and drives the wireless communication device to send out the information of the current position of the motor vehicle calculated by the global positioning device when the engine of the motor vehicle is switched off and when at least one of the vehicle abnormality detection sensors is triggered. The anti-thief controller further controls the at least one on-vehicle electronic component to execute a corresponding abnormal operation when starting the global positioning device and the wireless communication device, for example:
(1) the at least one on-vehicle electronic component is the central lock of the motor vehicle, and the corresponding abnormal operation is to repeatedly lock/unlock the central lock;
(2) the at least one on-vehicle electronic component is the air conditioning system of the motor vehicle, and the corresponding abnormal operation is to drive the air conditioning system to produce hot air to abnormally increase the room temperature inside the passenger room of the motor vehicle;
(3) the at least one on-vehicle electronic component is the fuel pump of the motor vehicle, and the corresponding abnormal operation is to drive the fuel pump to pump fuel to the engine of the motor vehicle intermittently;
(4) the at least one on-vehicle electronic component is the throttle valve of the engine of the motor vehicle, and the corresponding abnormal operation is to drive the throttle valve to intermittently block the supply of air to the engine of the motor vehicle;
(5) the at least one on-vehicle electronic component is an electric power seat of the motor vehicle, and the corresponding abnormal operation is to drive the electric power seat to move to a rear limit position;
(6) the at least one on-vehicle electronic component is an electric power seat of the motor vehicle, and the corresponding abnormal operation is to drive the electric power seat to move back and forth repeatedly;
(7) the at least one on-vehicle electronic component is the electric power seat back of an electric power seat of the motor vehicle, and the corresponding abnormal operation is to drive the electric power seat back of the electric power seat to incline forward and backward repeatedly;
(8) the at least one on-vehicle electronic component is a shift position sensor of an automatic transmission system of the motor vehicle, and the corresponding abnormal operation is to drive the shift position sensor to continuously output a same shift position signal;
(9) the at least one on-vehicle electronic component is an outside lamp of the motor vehicle, and the corresponding abnormal operation is to drive the outside lamp to blink repeatedly;
(10) the at least one on-vehicle electronic component is an inside lamp of the motor vehicle, and the corresponding abnormal operation is to turn on the inside lamp and then turn off the inside lamp repeatedly;
(11) the at least one on-vehicle electronic component is an audio device, and the corresponding abnormal operation is to drive the audio device to continuously produce a sound at a predetermined huge volume;
(12) the at least one on-vehicle electronic component is the electric power windows of the motor vehicle, and the corresponding abnormal operation is to open and close the electric power windows repeatedly;
(13) the at least one on-vehicle electronic component is the electric power sunroof of the motor vehicle, and the corresponding abnormal operation is to open and close the electric power sunroof repeatedly;
(14) the at least one on-vehicle electronic component is the electric power outside mirror of the motor vehicle, and the corresponding abnormal operation is to fold the electric power outside mirror back and forth repeatedly; and
(15) the at least one on-vehicle electronic component is the windshield wipers of the motor vehicle, and the corresponding abnormal operation is to move the windshield wipers over the windshield of the motor vehicle continuously.

The aforesaid on-vehicle electronic component and corresponding abnormal operation provide a post-intrusion anti-thief measure to obstruct and hinder normal functioning of the car, causing the thief to suffer from nerves and to further give up stealing the car.

### BRIEF DESCRIPTION OF THE DRAWINGS

FIG. 1 is a system block diagram of the present invention.

FIG. 2 is a schematic drawing showing an abnormal operation example of the present invention.

FIG. 3 is a schematic drawing showing another abnormal operation example of the present invention.

FIG. 4 is a schematic drawing showing a still another abnormal operation example of the present invention.

### DETAILED DESCRIPTION OF THE PREFERRED EMBODIMENT

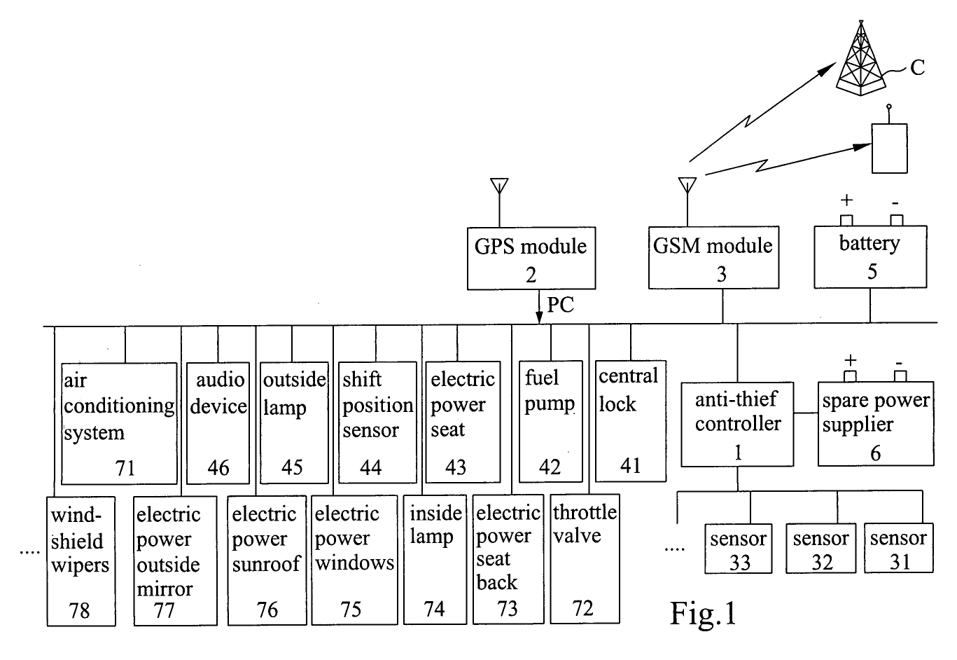

Referring to FIG. 1, a vehicle anti-thief system in accordance with the present invention is used in a car, comprising an anti-thief controller 1, a GPS module (global positioning device) 2, a GSM module (wireless communication device) 3, and a plurality of on-vehicle electronic components such as central lock 41, fuel pump 42, electric power seat 43, shift position sensor 44, outside lamp 45, audio device 46, and etc. The anti-thief controller 1, GPS module (global positioning device) 2, GSM module (wireless communication device) 3 and on-vehicle electronic components 41˜46 are respectively connected to a bus, for example a CAN (Controller Area Network) bus in the car (not shown). The anti-thief controller 1 has connected thereto a plurality of sensors 31,32,33 . . . that are respectively provided at different locations in the car.

When ACC is switched off and the vehicle anti-thief system is armed up after parking of the car, the anti-thief controller 1 starts scanning the sensors 31,32,33 . . . of the car to detect any abnormality. When the anti-thief controller 1 detected an induced status of one sensor 31 upon an abnormal condition of the car, for example, upon opening of one door of the car by an intruder, the anti-thief controller 1 immediately activates the GPS module 2 and the GSM module 3 to start initialization, controlling the GSM module 3 to send out the information of the current position of the car calculated by the GPS module 3 to the remote control center C by means of a short message, and to repeat the action of sending out the information of the current position of the car by a short message at an internal about 3˜5 minutes, for enabling the remote control center C to trace the traveling route of the car. At the same time, the remote control center C sends out the information of the current position of the car to the car owner's cellular telephone by means of a short message, and also provides the police center with the information of the traveling route of the stolen car for enabling the police center to pursue and apprehend the thief.

The main feature of the present invention is that the anti-thief controller 1 controls the on-vehicle electronic components to execute a respective corresponding abnormal operation to obstruct and hinder the thief from driving the car away when the car is been stolen.

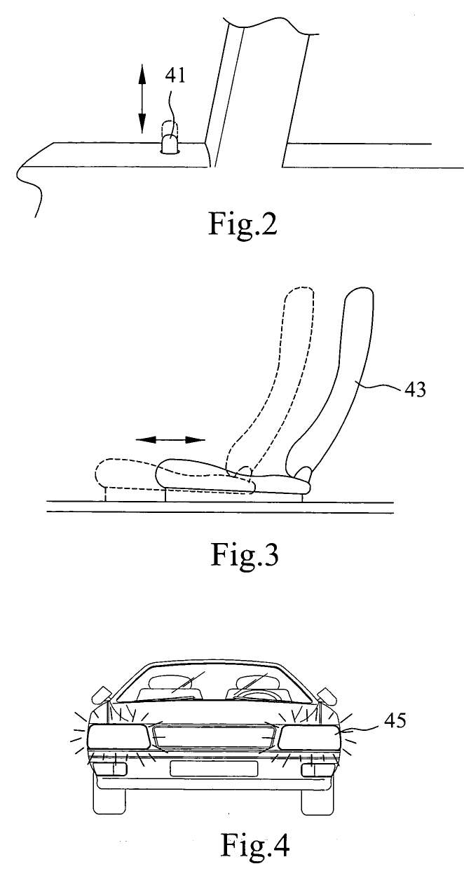

FIG. 2 shows an operation example of the present invention. Whether ACC is switched on or off, the anti-thief controller 1 controls the central lock 41 to repeatedly lock and unlock the doors of the car after intrusion of a thief into the car, making the thief to suffer from nerves and to give up stealing the car.

FIG. 3 shows another operation example of the present invention. According to this operation example, the anti-thief controller 1 controls the electric power seat 43 to repeatedly move back and forth after intrusion of a thief into the car, causing the thief unable to sit on the electric power seat 43 stably and to control the steering wheel or operate the accelerator or brake pedal accurately. Therefore, the vehicle anti-thief system obstructs and hinders the thief from driving the car normally, causing the thief to give up stealing the car. Further, the anti-thief controller 1 can be set to control the electric power seat 43 to move backward to the rear limit position, causing the thief unable to control the steering wheel or to step on the accelerator pedal or brake pedal. This operation example obstructs and hinders the thief from driving the car normally.

FIG. 4 shows still another operation example of the present invention. According to this operation example, the anti-thief controller 1 drives the head lamp of the outside lamp 45 to blink and to further attract passers-by's or a nearby police car's attention, thereby causing the thief to suffer from nerves and to give up stealing the car. The outside lamp 45 can be the headlamps of the car. Alternatively, the outside lamp set 45 can be the parking lamps, turning lamps, braking lamps, tail lamps, back lamps, or high position braking lamps of the car.

The anti-thief controller 1 can also be set to drive the audio device 46, for example, the horn, extra buzzer or Hi-Fi stereo of the car to produce an ear-splitting sound upon intrusion of a thief into the car, thereby attracting passers-by's or a nearby police car's attention and making the thief to suffer from nerves and to give up stealing the car.

Further, after ACC is switched on, the anti-thief controller 1 drives the fuel pump 42 to operate intermittently, causing unstable supply of fuel oil to the engine, and therefore the thief will be unable to drive the car smoothly and will be afraid to keep driving the car. Because the point of emphasis of the present invention is to obstruct and hinder the thief from stealing the car but not to hurt the body of the thief, it is suggested to have the aforesaid intermittent supply of fuel oil be executed only when the speed of the car is below 10 kms, or to have the anti-thief controller 1 stop the fuel pump 42 from pumping fuel oil to the engine when the speed of the car is zeroed (when the thief stopped the car upon red light). Thus, the thief will have no way out.

The anti-thief controller 1 can also control the shift position sensor 44 of the auto-transmission system to continuously output same shift position signal, for example, the parking shift signal or the neutral shift signal. Therefore, the ECU (electronic control unit) of the EMS (engine management system) of the car incorrectly identifies the auto-transmission system to be in the parking shift or neutral shift and will not drive the gear into the engaged position to move the car. Alternatively, the shift position sensor 44 can be set to continuously output a low shift signal (for example, 1^{st} or 2^{nd} shift signal), slowing down the car speed to escape.

The invention can also have two or more than two of the electronic components 41˜46 and their corresponding abnormal operations be combined together, enhancing the effect of obstructing and hindering the thief from stealing the car.

The vehicle anti-thief system further electrically connected to a battery 5. After ACC has been switched off and the vehicle anti-thief system has been armed up, the battery 5 keeps supplying electricity to the anti-thief controller 1 for working. When one of the sensors 31,32,33 . . . is triggered, the battery 5 provides the necessary working voltage to the GPS module 2, the GSM module 3 and the on-vehicle electronic components 41˜46 via the anti-thief controller 1. Further, a spare power supplier 6 is electrically connected to the anti-thief controller 1 to provide the necessary working voltage to the anti-thief controller 1 and further to the GPS module 2, the GSM module 3 and the on-vehicle electronic components 41˜46 via the anti-thief controller 1 in case the electric wire of the battery 5 is cut off by the thief.

Further, a GPRS module, 3C module, pager, or any of a variety of equivalent wireless communication devices may be used to substitute for the GSM module 3.

Further, the anti-thief controller 1 can be set to send out the aforesaid short messaging containing the information of the car's current position to the car owner's cellular telephone via the GSM module 3, for letting the car owner to report to the police.

In addition to the aforesaid operation of the present invention, the anti-thief controller 1 can be set to control the air conditioning system 71 of the car to produce hot air to abnormally increase the room temperature inside the passenger room of the car, for example, over 40° C., or to produce cold air and to further lower the inside temperature of the car to below 10° C. Alternatively, the anti-thief controller 1 can be set to stop the air conditioning system 71 from operating. Preferably, the anti-thief controller 1 is set to simultaneously lock the windows of the car when controlling the operation of the air conditioning system 71 of the car. This abnormal operation control effectively threatens the thief, causing the thief to give up stealing the car. Further, the anti-thief controller 1 can be set to control the throttle valve 72 to block the supply of air to the mixing chamber of the engine intermittently, causing an unstable combustion of the engine, and therefore the engine will be off or the car will not be able to move smoothly. The anti-thief controller 1 can also be set to control the electric power seat back 73, causing the electric power seat back 73 to repeatedly incline forwards and backwards, or to fall to the front side or the back side directly.

The anti-thief controller 1 can also be set to control the inside lamp 74 of the car to glint repeatedly, causing the thief's eyes to fell uncomfortable. Further, the anti-thief controller 1 can also be set to control the electric power windows 75 or electric power sunroof 76 of the car to repeatedly move up and down or to lock the electric power windows 75 or electric power sunroof 76 of the car in the open position.

The anti-thief controller 1 can also be set to control the electric power outside mirror 77 to repeatedly fold back and forth, or to lock the electric power outside mirror 77 in the close position. Further, the anti-thief controller 1 can also be set to control the windshield wipers 76 of the car to continuously move over the windshield and to continuously spray water.

As indicated above, the anti-thief controller 1 can control one or a number of the on-vehicle electronic components of the car to make a corresponding abnormal operation respectively. For example, the anti-thief controller 1 can control the air conditioning system 71, electric power windows 75 and electric power sunroof 76 of the car to make a corresponding abnormal operation at the same time or one after another, thereby interfering with the thief's mentality.

Although the present invention has been explained in relation to its preferred embodiment, it is to be understood that many other possible modifications and variations can be made without departing from the spirit and scope of the invention as hereinafter claimed.

What is claimed is:

1. A vehicle anti-thief system installed in a motor vehicle and adapted to obstruct normal operation of the motor vehicle, the vehicle anti-thief system comprising an anti-thief controller, a global positioning device, a wireless communication device, and at least one on-vehicle electronic component, said anti-thief controller having connected thereto a plurality of vehicle abnormality detection sensors, said anti-thief controller starting said global positioning device and said wireless communication device and driving said wireless communication device to send out the information of the current position of said motor vehicle calculated by said global positioning device when the engine of said motor vehicle is switched off and when at least one of said vehicle abnormality detection sensors is triggered, wherein:
said anti-thief controller further controls said at least one on-vehicle electronic component to execute a corresponding abnormal operation when starting said global positioning device and said wireless communication device, said at least one on-vehicle electronic component and said corresponding abnormal operation being selected from at least one of the following conditions:
(1) said at least one on-vehicle electronic component is the central lock of said motor vehicle, and said corresponding abnormal operation is to repeatedly lock/unlock said central lock;
(2) said at least one on-vehicle electronic component is the air conditioning system of said motor vehicle, and said corresponding abnormal operation is to drive said air conditioning system to produce hot air to abnormally increase the room temperature inside the passenger room of said motor vehicle;
(3) said at least one on-vehicle electronic component is the fuel pump of said motor vehicle, and said corresponding abnormal operation is to drive said fuel pump to pump fuel to the engine of said motor vehicle intermittently;
(4) said at least one on-vehicle electronic component is the throttle valve of the engine of said motor vehicle, and said corresponding abnormal operation is to drive said throttle valve to intermittently block the supply of air to the engine of said motor vehicle;
(5) said at least one on-vehicle electronic component is an electric power seat of said motor vehicle, and said corresponding abnormal operation is to drive the electric power seat to move to a rear limit position;
(6) said at least one on-vehicle electronic component is an electric power seat of said motor vehicle, and said corresponding abnormal operation is to drive the electric power seat to move back and forth repeatedly;
(7) said at least one on-vehicle electronic component is the electric power seat back of an electric power seat of said motor vehicle, and said corresponding abnormal operation is to drive the electric power seat back of the electric power seat to incline forward and backward repeatedly;
(8) said at least one on-vehicle electronic component is a shift position sensor of an automatic transmission system of said motor vehicle, and said corresponding abnormal operation is to drive said shift position sensor to continuously output a same shift position signal;
(9) said at least one on-vehicle electronic component is an outside lamp of said motor vehicle, and said corresponding abnormal operation is to drive said outside lamp to blink repeatedly;
(10) said at least one on-vehicle electronic component is an inside lamp of said motor vehicle, and said corresponding abnormal operation is to turn on said inside lamp and then turn off said inside lamp repeatedly;
(11) said at least one on-vehicle electronic component is an audio device, and said corresponding abnormal operation is to drive said audio device to continuously produce a sound at a predetermined huge volume;
(12) said at least one on-vehicle electronic component is the electric power windows of said motor vehicle, and said corresponding abnormal operation is to open and close said electric power windows repeatedly;
(13) said at least one on-vehicle electronic component is the electric power sunroof of said motor vehicle, and said corresponding abnormal operation is to open and close said electric power sunroof repeatedly;
(14) said at least one on-vehicle electronic component is the electric power outside mirror of said motor vehicle, and said corresponding abnormal operation is to fold said electric power outside mirror back and forth repeatedly; and
(15) said at least one on-vehicle electronic component is the windshield wipers of said motor vehicle, and said corresponding abnormal operation is to move said windshield wipers over the windshield of said motor vehicle continuously.

2. The vehicle anti-thief system as claimed in claim 1, wherein said anti-thief controller is electrically connected to a battery of said motor vehicle to obtain electricity from the battery, said battery further provides electricity to said global positioning device and said wireless communication device and said at least one on-vehicle electronic component.

3. The vehicle anti-thief system as claimed in claim 2, wherein said anti-thief controller is further electrically connected to a spare power supplier of said motor vehicle, said spare power supplier further provides electricity to said global positioning device and said wireless communication device and said at least one on-vehicle electronic component.

4. The vehicle anti-thief system as claimed in claim 1, wherein said wireless communication device is adapted to send out the information of the current position of said motor vehicle calculated by said global positioning device to a cellular telephone of the owner of said motor vehicle wirelessly.

5. The vehicle anti-thief system as claimed in claim 1, wherein said wireless communication device is adapted to send out the information of the current position of said motor vehicle calculated by said global positioning device to a remote control center wirelessly.

6. The vehicle anti-thief system as claimed in claim 5, wherein said remote control center sends out the information of the current position of said motor vehicle received from said wireless communication device of said motor vehicle to a cellular telephone of the owner of said motor vehicle wirelessly.
